(19) United States
(12) Patent Application Publication
(10) Pub. No.: US 2004/0172872 A1
(43) Pub. Date: Sep. 9, 2004

(54) Flag waving apparatus

(76) Inventor: Robert Witkowski, Toms River, NJ (US)

Correspondence Address: CLIFFORD G. FRAYNE, Suite 7A, 136 Drum Point Road, Brick, NJ, 08723, US

(21) Appl. No.: 10/784,104

(22) Filed: Feb. 23, 2004

Related U.S. Application Data
(60) Provisional application No. 60/451,154, filed on Mar. 3, 2003.

(51) Int. Cl. G09F 21/04

(52) U.S. Cl. 40/593

(57) ABSTRACT

A flag waving apparatus having a source of electrical energy and an on/off switch for initiating and ending the operation of the flag waving apparatus, the flag waving apparatus comprising a housing member, the housing member having positioned therein an electric motor attached to a sliding pivot to which there is attached a flag pole receipt conduit which extends upwardly through a slot in the top panel of the housing member, the housing member further having a light source positioned therein, the flag pole receiving conduit for the slidable insertion of the flag pole into the conduit, the conduit reciprocating in an arc of less then 180 degrees, the housing further having a removable panel having a message thereon back lit by the light source and a suction cup member mounted to each end panel of the housing, the suction cup member pivotal from a horizontal engaging orientation to a vertical or angular engaging orientation.

### RELATED APPLICATIONS

Applicant claims the benefit of provisional application Serial No. 60/451,154, filed Mar. 3, 2003.

### BACKGROUND OF THE INVENTION

1. Field of the Invention

The present invention is related to an electronic flag waving apparatus which is particularly suitable for installation in the rear or side windows of a vehicle, but would also have application to mounting on a house window or desk or other suitable piece of furniture.

2. Description of the Prior Art

U.S. Pat. No. 5,450,811 to Heiland discloses a warning sign assembly which has a pivoting flag mounted thereto and electronically actuated in order to visually gain the attention of an individual or motorist to cause the individual or motorist to read the text context of the warning sign.

U.S. Pat. No. 4,461,234 to Bounds discloses a novelty item in the form of a flag waving machine which is suitable for use on both desk tops or indoor locations, or to drive larger flags in outdoor display.

U.S. Pat. No. 6,282,823 to Brown discloses a courtesy device comprising a simulated hand mounted on a staff attached to a motor means which reciprocates thereby simulating a courtesy wave.

### OBJECTS OF THE INVENTION

An object of the present invention is to provide for a novel flag waving apparatus mountable to the rear window or side window of a vehicle.

Another object of the present invention is to provide for a novel flag waving apparatus mountable on a desk or other suitable piece of furniture.

A still further object of the present invention is to provide for a novel flag waving apparatus which is mountable on the interior of a house window or commercial window.

### SUMMARY OF THE INVENTION

A flag waving apparatus having a source of electrical energy and an on/off switch for initiating and ending the operation of the flag waving apparatus, the flag waving apparatus comprising a housing member, the housing member having positioned therein an electric motor attached to a sliding pivot to which there is attached a flag pole receipt conduit which extends upwardly through a slot in the top panel of the housing member, the housing member further having a light source positioned therein, the flag pole receiving conduit for the slidable insertion of the flag pole into the conduit, the conduit reciprocating in an arc of less then 180 degrees, the housing further having a removable panel having a message thereon back lit by the light source and a suction cup member mounted to each end panel of the housing, the suction cup member pivotal from a horizontal engaging orientation to a vertical or angular engaging orientation.

### BRIEF DESCRIPTION OF THE DRAWINGS

FIG. 1 is a front view of the flag waving assembly;

FIG. 2 is a top cutaway view of the flag waving assembly;

FIG. 3 is an end cutaway view of the housing of the flag waving assembly;

FIG. 4 is a top cutaway view of the housing of the flag waving assembly; and

FIG. 5 is an end cutaway view of the flag waving assembly.

### DETAILED DESCRIPTION OF THE INVENTION

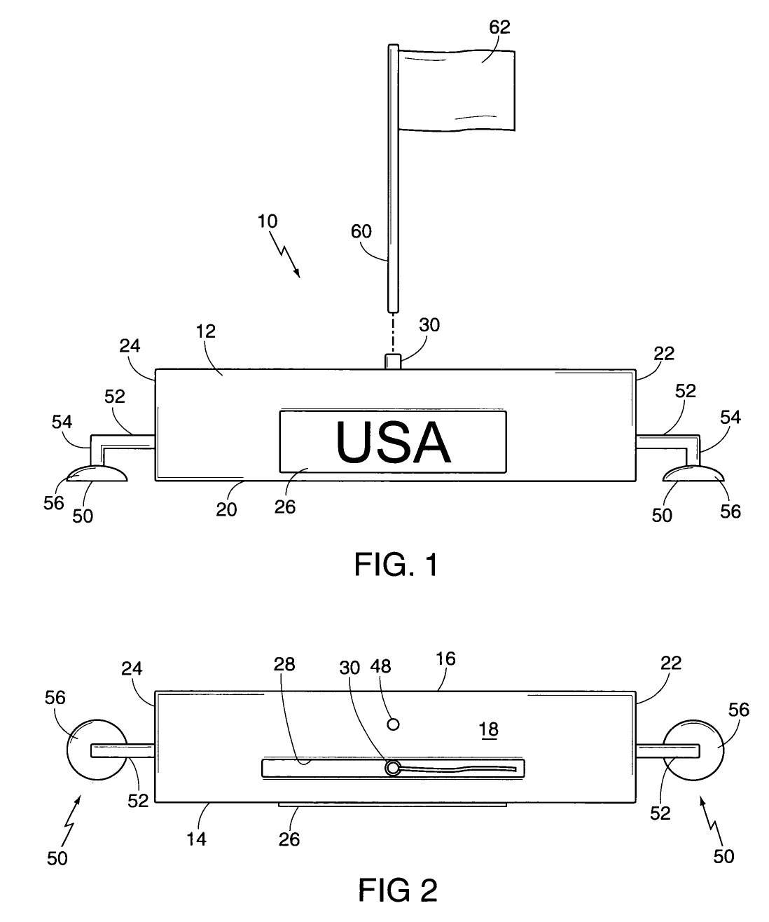

FIG. 1 is a front view of the flag waving assembly 10 of the present invention. Flag waving assembly 10 comprising a housing member 12, generally rectangular in shape having a front panel 14, a rear panel 16, a top panel 18, and a bottom panel 20, and two opposing end panels 22 and 24. Front panel 14 of housing 12 has a removable panel member 26 on which a text or message may be formed and be backlit from a light source within the housing member 12 hereinafter described.

FIG. 2 is a top cutaway view of housing member 12 revealing a slot 28 generally parallel with the front panel 14 and the rear panel 16. Extending upwardly through slot 28 is a flag staff receiving tube 30.

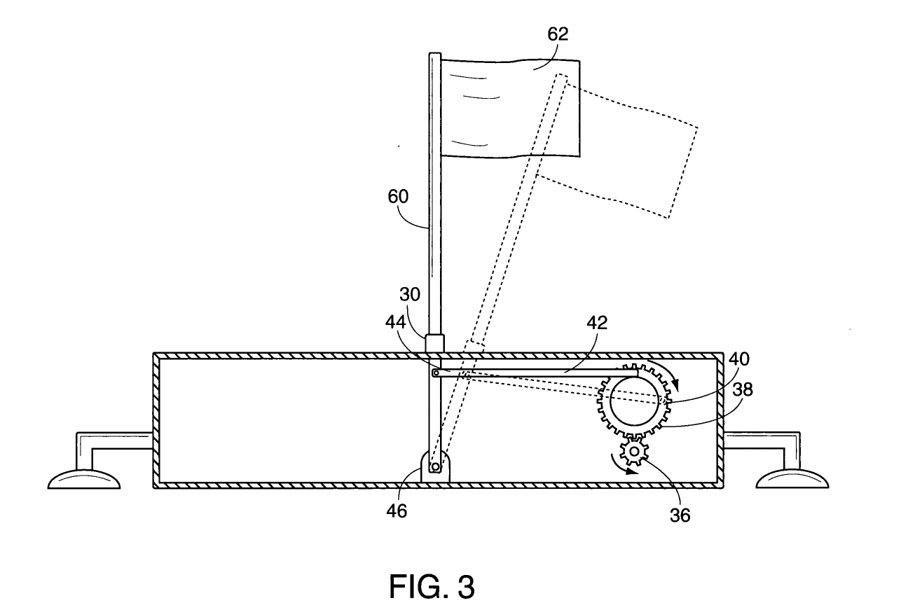

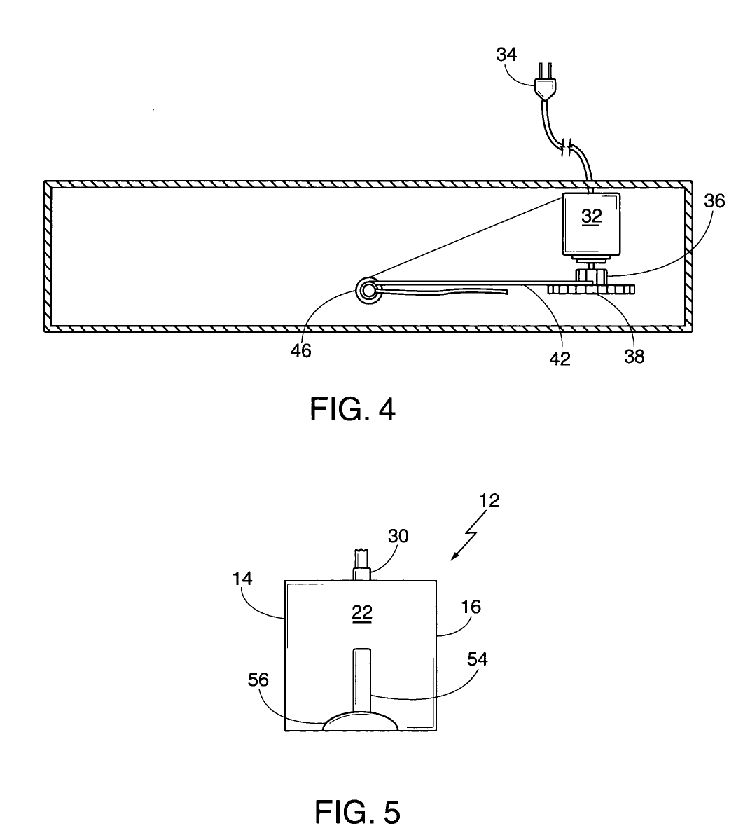

Referring now to FIGS. 3 and 4, a top end cutaway view and front cutaway view of housing 12, there is illustrated an electric motor means 32 in communication with an appropriate source of electrical energy 34, either battery power or a direct source of current. Electric motor means 32 drives a pinion gear 36 in rotational relationship with a second gear 38. Mounted on the periphery 40 of second gear 38 is a reciprocating shaft 42 which is secured at its opposing end 44 to flag staff receiving tube 30 which in turn is secured within housing 12 to a pivot 46.

As pinion gear 36 rotates and drives second gear 38, the reciprocating shaft 42 moves from a point proximate end panel 22 to a point further away from end panel 22. Reciprocating shaft 42 thus moves flag staff receiving tube 30 in a reciprocating motion towards end panel 22 and thence towards end panel 24, this reciprocating or waving motion repeating as long as electric motor means 32 is engaged.

Also positioned within housing 12 as illustrated in FIG. 3 is a light source 46 connected in series to electric motor means 32 and the source of electrical energy 34. An aperture 48 in the top panel 18 of housing 12 allows transmitted light from said light source 46 to illuminate the arch traversed by flag staff receiving tube 30. The light source 46 is also utilized to back light panel member 26 and a message or text disposed thereon. In the instant example, panel member 26 is substantially opaque with the message or text, in this case the letters “USA”, being formed of a substantially translucent material.

FIG. 5 is an end cutaway view of housing 12 of flag waving assembly 10. Each end has secured thereto a rotatable suction member assembly 50. Suction member assembly 50 comprises journal shaft 52 rotatably deposed through end panels 22 and 24 and perpendicular thereto. Secured to the outwardly extending end of journal shaft 52 is a second shaft 54 perpendicularly disposed with relationship to journal shaft 52, the end of which is secured to a section cup 56. The same assembly appears at the opposing end panel 24 of flag waving assembly 10. The length of second shaft 54 in cooperation with the suction cup 56 is such that when suction cup 56 is compressed to adhere to a surface, such compression will put it in a plane substantially identical to that of bottom panel 20. The rotatable aspect of suction cup assembly 50 allows for the flag waving assembly 10 to be secured to a flat surface in a horizontal manner, such as a desk, or when rotated 90 degrees, to allow for the suction cups 56 to engage a vertical surface, such as a side window of a vehicle or the window of a dwelling, and when rotated to any angle between the horizontal and 90 degrees, to allow for the housing member 12 to be secured to a slanted rear window such as that of an automobile.

In those instances where the vehicle window such as the rear window, has a great degree of curvature, Applicant's assembly includes an adaptor elbow 58 for engagement with the flag staff receiving tube 30 to offset the angle between a flag staff 60 so as to permit the reciprocation of the flag staff 60 and flag 62 without engaging the curvature of the window.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A device permitting the user to exhibit a sign of patriotism or other indicia to others, the device suitable for mounting on the inside of a motor vehicle window, and also capable of being mounted on other suitable pieces of furniture or surfaces, said device comprising:
a housing, said housing defined by opposing end panels, opposing side panels, a base panel and a top panel, said top panel having a longitudinally disposed slot therein;
a motor means secured within said housing, said motor means in communication with a power source; said motor means secured to a gear and pinion assembly, said gear and pinion assembly having secured in pivotal relationship to the outer periphery of said gear, a first end of a shaft means, an opposing end of said shaft means being secured to a second tubular shaft means, said second tubular shaft means having a first end pivotally mounted within said housing proximate said base panel of said housing, said second tubular shaft means extending upwardly through said slot in said top panel of said housing, said second end of said second tubular shaft means having slidably secured therein a flag shaft and flag, reciprocating in said slot under the influence of said first shaft means and said gear and pinion assembly.

2. The device in accordance with claim 1 wherein said power source is a battery power source positioned within said housing.

3. The device in accordance with claim 1 wherein said power source is an external power source in communication with said electric motor.

4. The device in accordance with claim 1 wherein said opposing side panel of said housing each have secured thereto a pivotal L-shaped member, a leg of which has secured thereto a suction means.

5. The device in accordance with claim 1 wherein said front wall of said housing means is formed with a translucent window and there is included in said housing means, a light source, back lighting said translucent window, said translucent window having formed thereon a text message or indicia.

6. The device in accordance with claim 5 wherein said light means is in communication with said battery power source.

7. The device in accordance with claim 5 wherein said light means is in communication with said external power source.

8. The device in accordance with claim 1 wherein said suction means are utilized to secure said housing means to a surface between the vertical or horizontal surface.
